(19) United States
(12) Patent Application Publication
(10) Pub. No.: US 2022/0080626 A1
(43) Pub. Date: Mar. 17, 2022

(54) PROCESS FOR MANUFACTURING ANATOMICAL MODELS

(71) Applicant: CELLA MEDICAL SOLUTIONS S.L., MURCIA (ES)

(72) Inventor: García Calderón DARIO, MURCIA (ES)

(73) Assignee: CELLA MEDICAL SOLUTIONS S.L., MURCIA (ES)

(21) Appl. No.: 17/419,906

(22) PCT Filed: Dec. 27, 2019
(86) PCT No.: PCT/ES2019/070895

§ 371 Date: Jun. 30, 2021

(30) Foreign Application Priority Data
Dec. 31, 2018 (EP) 18215992.1

(51) Int. Cl. B29C 33/38; B29C 64/386; B29C 39/10; B29C 39/26; B33Y 10/00; B33Y 50/00; B33Y 80/00

(52) U.S. Cl. CPC B29C 33/3842; B29C 64/386; B29C 39/10; G09B 23/30; B33Y 10/00; B33Y 50/00; B33Y 80/00; B29C 39/26

(57) ABSTRACT

A process for the manufacture of anatomical models which, from images obtained and the creation of editable and printable files, includes a sub-process for generating main moulds, a sub-process for generating internal elements, a sub-process for positioning the internal elements which when these include soft elements comprises a step of reversible stiffening, a sub-process for integrating the internal elements comprising a step of pouring of parenchyma and an demoulding step and a post-processing sub-process.

The invention, as stated in the title, relates to a process for manufacturing anatomical models, that is, structures of the human body, that are true in shape, size, texture or resistance with respect to the biological structure, which facilitates diagnosis and allows programming, preparing and simulating surgeries. On the other hand these anatomical models are extremely useful for teaching, since they allow not only visualising different parts of the body, but also interacting with them and training in surgical techniques without having to use human bodies.

The relevant field of the art of this invention is that of the health sciences, especially medicine and more specifically the sector for the manufacture of anatomical models.

### BACKGROUND OF THE INVENTION

The production of anatomical models has always been of interest due to their usefulness for study or practice.

The recent eruption of new technologies allows producing images of organs even from inside the body, which can then be printed using 3D printing.

We can find some examples of these techniques in the following publications and patent literature.

The document by DONEY, E. et al. “3D printing of preclinical X-ray computed tomographic data sets”. J. VIS. EXP. 22.03.2013.No. 73, e50250, doi:10.3791/50250,pages 1-6. [online], [viewed on 12.11.203]. Consulted on the internet <http://www.jove.com/video/50250/3d-printing-of-preclinical-x-ray-computed-tomographic-data-sets> reveals a process for the 3D printing of a bone structure or part of one from the scanning of a vertebrate.

The document by TAM, M. D. et al. “3-D printout of a DICOM file to aid surgical planning in a 6 year old patient with a large scapular osteochondroma complicating congenital diaphyseal aclasia”. RADIOLOGY CASE. January 2012; Vol. 6, No. 1, pages 31-37. DOI:0.3941/jrcr.v6i1.889 http://www.radiologycases.com/index.php/radiologycases/article/view/889/pdf se4 relates to a case in which a DICOM image (Digital Imaging and Communication in Medicine, a worldwide standard for medical image exchange) of a bone tumour is manipulated for 3D printing for diagnosis and preparation for surgery.

The scientific article by Zein, N. N. et al. “Three-dimensional print of a liver for preoperative planning in living donor liver transplantation.” Uver Transpl. 19, 1304-1310 (2013) performs a 3D print of a liver using this process.

Other scientific publications such as Valverde, I. et al “3D printed cardiovascular models for surgical planning in complex congenital heart diseases.” Journal of Cardiovascular Magnetic Resonance 17, P196 (2015); Tam, M. D. B. S., Laycock, S. D., Brown, J. R. 1. & Jakeways, M. “3D printing of an aortic aneurysm to facilitate decision making and device selection for endovascular aneurysm repair in complex neck anatomy.” J. Endovasc. Ther. 20, 863-867 (2013); Wang, J.-O. et al. “Printed three-dimensional anatomic templates for virtual preoperative planning before reconstruction of old pelvic injuries: Initial Results.” Chinese Medical Journal 128, 477 (2015) deal with 3D printing of different anatomical models.

Document ES2523419 describes a manufacturing method for specific anatomical models for each patient via a first step, which is not deemed to have inventive step, consisting in the generation of a 3D model of the structure for which we want to create an anatomical model from an imaging diagnosis of the patient and a second step in which the 3D model is printed directly using a 3D printer.

The direct printing of the part described in the stated documents on the one hand limits obtaining models of soft organs since the printing of these requires expensive materials. Moreover, there is no current method that achieves suitable transparency since this is one of the limitations of the layering in 3D printing. On the other hand, none of the cited documents combines different independent elements by positioning them on the final anatomical model as in the case of the internal elements of organs or tumours.

The publication “Patient specific phantom in bimodal image navigation system” by Jan Juszczyk, Bartlomiej Pycinski and Ewa Pietka, Member, IEEE, from the Annual International Conference of the IEEE Engineering in Medicine and Biology Society (EMBC) 20150825 IEEE 25/08/2015 Vol: Pages: 2908-2911 relates to the modelling of organs that are joined to one another by axes that facilitate their positioning in a gelatinous body in which nesting areas are first created to house the organs while these are joined to one another by different axes, and later the axes are removed and the gelatinous body is completed, with a cylindrical shape in the case shown. This system cannot be used for the positioning of soft parts since fastening by axes does not allow this.

Patent ES2615034 relates to a process for the manufacture of anatomical models comprising different elements, positioned using soluble filaments, each of these having the consistency with which they occur in nature, thus its usefulness for simulating surgical processes using anatomical models as test models. However, the process described in said patent can be improved upon regarding the demoulding of certain parts, the positioning of internal elements or the optimisation of certain processes for emptying or refilling moulds or discriminating parts by size for the application of different processes.

The subject matter of this invention is a process for obtaining anatomical models that are true to the elements, sizes, shapes, resistance and textures of the organs and biological structures they replicate, solving the aforementioned problems and limitations.

Another subject matter of this invention are the anatomical models obtained with the processes described in the claims.

### DESCRIPTION OF THE INVENTION

In order to solve said problems, we propose a process for manufacturing anatomical models that allows the true reproduction of textures, resistances, colours, shapes and other elements that provide realism and interest to the models obtained.

The process for manufacturing anatomical models starts by capturing one or more images using common techniques such as CAT (computerised axial tomography), NMR (nuclear magnetic resonance), ultrasound or any other, the processing of such images to select (segment) the different elements of the anatomical structure of interest from the images obtained and obtaining one or more editable computer files. Having obtained the editable images, the manufacturing process of anatomical models comprises the following sub-processes:

1. A sub-process for generating the main moulds.

2. A sub-process for generating internal elements comprising a pouring step.

3. A sub-process for positioning the internal elements.

4. A sub-process for integrating the internal and external elements comprising a pouring step.

5. A post-processing sub-process.

For the purposes of this patent we shall call:

External elements the volumes of the anatomical model that are in contact with the exterior, comprising the parenchyma and, as appropriate, the internal elements.

Internal elements the parts of the anatomical model intended to be totally or partially embedded within the parenchyma. These internal elements may be rigid (cysts, bones, vasculatures or tumours, amongst others) or soft (vessels or muscles amongst others).

Parenchyma is the pouring material of the anatomical model which provides its consistency and which shall bind together all of the elements thereof.

Filling material is the pouring material that is not parenchyma and which shall normally be used to fill in internal elements.

Positioning is the process by which the internal elements are placed in their correct location before being embedded.

Main moulds are the moulds used to form the external elements.

Secondary moulds are the moulds used to form some of the internal elements.

Pouring nozzles are openings that exist in the main or secondary moulds that allow pouring material inside them, whether parenchyma or another filling material.

Auxiliary positioning elements are elements that contribute towards placing and fastening certain internal elements during the manufacturing process. One example of this type of auxiliary elements are rods. These auxiliary positioning elements may go all the way through the anatomical model or not.

Small parts are parts with a volume that is usually less than 500 ml and large parts are those with a volume that is usually more than 500 ml. The division between small parts and large parts based on volume is to be used as a guideline, thus the use of the expression usually since there may be cases in which to produce a small part, due to an irregular shape or a large difference in the length and orientation of its axes, it may be advisable to create a larger part, the opposite being more difficult to be the case.

Pouring shall be the set of operations carried out to introduce into a mould, whether main or secondary, the pouring material, which shall be a fill in material or parenchyma, as required, with this pouring process being by injection or gravity, and which in addition to the operation itself of introducing the material may comprise any prior handling of the filling material and any subsequent steps for curing said material.

With respect to the above we shall now explain the different sub-processes and steps.

1. The sub-process for generating the main moulds comprises the following steps:

Computer modelling of the editable images until obtaining a file that is compatible with 3D printing. The computer modelling comprises not only the modelling of the shape of the anatomical model itself or the shape of its mould, but also the virtual modelling of the positioning elements, their virtual path and their relationships (housings, anchor points or support points) with the main mould, thus calculating the predetermined cross-section and length of these auxiliary positioning elements.

Discrimination between small parts and large parts.

For the small parts, the element is prototyped in positive in order to later immerse it in casting silicone, removing the prototype once this has cured and thus obtaining a mould.

For large parts the mould is printed, in this case a thin sheath that allows subsequent demoulding by applying heat. The thickness is of approximately 2 millimetres, and can be up to 15 millimetres. This is why the main mould is more like a sheath than a conventional mould. This allows saving on material, time and ease of demoulding for any geometry.

Optionally the application of an additive on the inner face of the moulds to smooth out the surface.

Once the sub-process for the generation of main moulds is completed or even at the same time takes place the sub-process for the creation of internal elements.

2. The sub-process for the creation of internal elements comprises the following steps:

Computer modelling of the editable images until obtaining a file that is compatible with 3D printing. This computer modelling comprises the modelling of the virtual path of the auxiliary positioning elements as well as their relationship with the internal element (anchors, rest areas, housings, openings or supports), calculating the cross-section and length of these auxiliary positioning elements. A step for discriminating between rigid elements and soft elements where the rigid internal elements the files obtained in the first step of this sub-process are 3D printed and for the soft, transparent or translucent internal elements with different colours a secondary mould is obtained that then allows obtaining an element by pouring filling material into it, according to the following sub-steps:

Discrimination by size between small parts and large parts: For internal elements that are large parts, the secondary mould is obtained preferably following the same process as for the generation of the main moulds that are large parts; internal elements that are small parts are obtained following the process described below.

Prototyping of internal elements in positive and in a soluble material, preferably ABS.

Obtaining a secondary mould by immersing the prototype in silicone, curing the silicone and removing the prototype to obtain the mould or secondary mould.

Adding the pouring nozzles to the mould.

Sealing the mould.

Pouring the filling material and curing of the material, all this with temperature control. Comprising the following operations:

Prior cooling of the filling material, especially in the case of urethane rubber at a temperature around 5° C. Since an exothermic reaction will take place after the pouring, and the higher the temperature the faster the curing speed, it is necessary to start from a low temperature of the filling material in order to slow down the curing time so that the relevant handling can take place, which comprises subjecting it to a vacuum and pouring it into the mould at atmospheric pressure.

Once the pouring operation is completed, the curing starts in a reboiler at a pressure of 70 psi with a temperature of more than 25° C.

Demoulding.

Once the previous two processes have been completed the internal elements are then positioned in the main moulds.

3. Sub-process for positioning the internal elements in the main moulds.

The internal elements must be placed in their exact position inside the anatomical model. Sometimes it is easy to position them since these internal elements are in contact with or inserted into another anatomical element and are fastened or supported by the geometry of the main moulds itself without requiring auxiliary positioning elements, however, other times these internal elements must occupy a position that is far removed from any possible support on the main moulds, as if they were floating in the parenchyma.

In said case, the positioning of these elements is performed using auxiliary positioning elements, such as for example rods, the location, supports, anchors, housings, cross-section and length of which has already been taken into account or predetermined in the computer modelling both of the main moulds and of the internal elements.

Based on the above, the sub-process for positioning the internal elements comprises the following steps:

Computer modelling of the paths of the auxiliary positioning elements, such as for example rods, compatible with the modelling of the supports and anchors for same in the main moulds and in the internal elements. Thus, when modelling the paths of the auxiliary positioning elements their virtual path is created, comprising the openings and housings, supports, anchors or resting areas that said auxiliary positioning element shall occupy in the internal elements and the moulds, and their cross-section and length shall be predetermined. For reasons of organisational consistency, these openings and housings are modelled in the sub-processes for creating the main moulds and internal elements.

Obtaining the rods. The rods, with a predetermined cross-section and length, shall preferably be in metal if they go through the moulds since, once the internal elements have been fastened by the addition and curing of the parenchyma, the rods shall be removed and the holes filled with rigid or soft material as appropriate, and they shall be in methacrylate if they are to remain inside, so that the refractive index of the material is as close as possible to that of the parenchyma.

Fastening of the internal elements to the rods and of the latter to the main moulds pursuant to the positioning calculated in the computer model.

For soft internal elements, the positioning sub-process also comprises a stiffening step of same using a reversible process such as by freezing.

4. A sub-process for integration of the internal and external elements.

Once the main moulds, internal elements and auxiliary positioning elements have been obtained and all these internal elements have been positioned in the main moulds, all the elements are integrated in order to create the anatomical model.

This integration process comprises the following steps:

Closing of the main moulds with the internal elements already positioned inside.

Introduction of the parenchyma, by gravity or injection, through the pouring nozzles and curing thereof with temperature control. To do this the parenchyma is subjected to a prior vacuum operation in a vacuum hood so that it is extracted and poured at atmospheric pressure into the main mould, for which the procedure is as follows, especially in the case of urethane rubber:

Cooling of the parenchyma, especially in the case of urethane rubber. Since an exothermic reaction will take place after the pouring, and the higher the temperature the faster the curing speed, it is necessary to start from a low temperature of the filling material in order to slow down the curing time so that the relevant handling can take place, which comprises subjecting it to a vacuum and pouring it into the mould at atmospheric pressure.

Once the pouring or injection operation is completed, the curing starts in a reboiler at a pressure of 70 psi with a temperature of more than 25° C.

The parenchyma comprises:

For rigid elements, urethane rubber, since it has a suitable viscosity for pouring, short vacuum times are required to remove bubbles, and this allows obtaining a suitable transparency for our requirements, it cures at temperatures that do not deform the internal elements, it can be sanded down and it is not toxic.

For soft elements the parenchyma comprises silicone or PVC.

Once the parenchyma has cured it is demoulded, for which the assembly is heated to a temperature between 60° C. and 100° C., since from 60° C. the PLA in which the main mould is made starts to have a certain flexibility, whereas at more than 100° C. the demoulding operations become complicated since they involve a risk to the operator. Preferably the demoulding operation is performed at 70° C.

The assembly is heated by subjecting it to a hot environment, preferably a hot fluid that may be water, for example, although we do not reject others such as oil or others.

Once the assembly has been heated it is demoulded. Removal, as appropriate, of positioning elements such as rods, and filling of the holes left by these with the same parenchyma that was poured into the main mould during the injection process.

5. A post-processing sub-process.

After demoulding all the elements of the anatomical model are integrated, and a post-processing is performed comprising:

Buffing to remove any burrs and imperfections the mould may have caused.

Application of a protective lacquer that also favours transparency.

### DESCRIPTION OF A PREFERRED EMBODIMENT OF THE INVENTION

Described below is an embodiment of the invention that is neither unique nor limiting but merely explanatory.

The process for manufacturing anatomical models starts by capturing one or more images using common techniques such as CAT (computerised axial tomography), NMR (nuclear magnetic resonance), ultrasound or any other, the processing of such images to select (segment) the different elements of the anatomical structure of interest from the images obtained and obtaining one or more editable computer files.

Having obtained the editable images, the manufacturing process of anatomical models comprises the following sub-processes:

1. A sub-process for generating the main moulds.

2. A sub-process for generating the internal elements.

3. A sub-process for positioning the internal elements.

4. A sub-process for integration of the internal and external elements.

5. A post-processing sub-process.

The sub-process for generating the main moulds includes the following steps:

Computer modelling of the editable images until obtaining a file that is compatible with 3D printing. The computer modelling comprises not only the shape itself of the anatomical model to be manufactured, but also the modelling of the auxiliary positioning elements, which implies their housings (anchors, rest areas, supports, and position openings) and the openings for the pouring nozzles through which the parenchyma will be poured or injected, as well as determining the cross-section and length of the auxiliary positioning elements.

In the step for discriminating by size, since we intend to manufacture a large piece, we choose to print the mould.

Printing the mould in PLA. This main mould has a thickness of 2 millimetres, which makes it more like a sheath than a conventional mould. This allows saving on material, time and ease of demoulding for any geometry.

Application of an additive on the inner face of the moulds to smooth out the surface.

The sub-process for the generation of internal elements, in this case soft internal elements, includes the following steps:

Computer modelling of the editable images until obtaining a file that is compatible with 3D printing. The computer modelling comprises not only the shape of the part to be manufactured, but also the housings (anchors, resting areas, supports or positioning openings) for the auxiliary positioning elements and the openings for the pouring nozzles through which the filling material shall be poured or injected.

Since we intend to manufacture a small part, when discriminating by size we have chosen to obtain a secondary mould through the following sub-steps:

Prototyping of the internal elements in positive by printing in ABS.

Immersion of the printed prototype in silicone and removal of the prototype to obtain the secondary mould.

Adding the pouring nozzles to the mould.

Sealing the mould.

Pouring of the filling material. The filling material has previously been subjected to a vacuum operation outside the mould in order to be subsequently poured at atmospheric pressure into the mould.

The filling material is silicone.

Demoulding.

The sub-process for positioning the internal elements includes the following steps:

Obtaining auxiliary positioning elements, in this case metal rods with a predetermined cross-section and length from modelling the virtual path of the auxiliary positioning elements.

A stiffening step of the internal elements using a reversible process, in this case freezing, in order to provide the sufficient stiffness as to be able to place them with the rods.

Fastening of the internal elements to the rods and of the latter to the main moulds pursuant to the positioning calculated in the computer modelling of the virtual path.

The sub-process for integration of the internal and external elements comprises the following steps:

Closing of the main moulds with the internal elements already positioned inside.

Pouring of the parenchyma material through the pouring nozzles, in this case this comprises urethane rubber. To do this such material is subjected to a prior cooling to 5° to slow down its curing. After such prior cooling the parenchyma material is subjected to a vacuum operation under a vacuum hood and is subsequently removed from it and poured at atmospheric pressure into the main mould.

The curing is performed in a reboiler with controlled temperature at more than 25° C.

Once the parenchyma has cured the entire assembly is heated with water at 70° C. for a subsequent demoulding and removal of the rods.

Once the rods have been removed the holes are filled with the same parenchyma material used.

A post-processing sub-process.

After demoulding there is a post-processing sub-process comprising:

Buffing to remove imperfections and to smooth out surfaces.

Application of a protective lacquer that also favours transparency.

1-19. (canceled)

20. A method for the manufacture of anatomical models of the type comprising the capturing of one or more images, using and processing of such images to select (or segment) different elements of an anatomical structure of interest from the images obtained, obtaining one or more editable computer files for the subsequent creation, and using 3D printing of elements of the anatomical model and moulds for its total or partial manufacture, comprising:
1. a sub-process for generating main moulds comprising modelling of a virtual path of auxiliary positioning elements and their relationship with the main mould, calculating a cross-section and length of these auxiliary positioning elements, a step for discriminating by size between large parts and small parts and a step for creating the mould;
2. a sub-process for generating internal elements comprising modelling the virtual path of the auxiliary positioning elements and their relationship with the internal element, calculating a cross-section and length of such elements, a step for discriminating between rigid elements and soft elements, a step for discriminating by size between large parts and small parts, and in the case of soft parts, a step for generating secondary moulds, a step of pouring filling material and an demoulding step;
3. a sub-process for positioning the internal elements, which when it includes soft elements comprises a step of reversible stiffening;
4. a sub-process for integrating the internal elements comprising a step of pouring of parenchyma and a demoulding step; and
5. a post-processing sub-process.

21. The method according to claim 20, wherein in the case of the large parts of sub-processes 1 and 2, further comprising a step for creating the mould, whether a main mould or a secondary mould, wherein the mould is printed with a thickness between 2 mm and 15 mm

22. The method according to claim 21, wherein the mould, whether main or secondary, is printed in PLA.

23. The method according to claim 3, wherein an additive is also applied to the inner face of the main mould in order to smooth out the inner surface.

24. The method according to claim 20, wherein the sub-process for generating main moulds and the sub-process for generating internal elements comprise, in the case of small parts, a step for creating the mould comprising the prototyping of the element in positive, immersing it in silicone, curing the silicone and removing the prototype.

25. The method according to claim 20, wherein the sub-process for generating internal elements, in the case of rigid elements, comprises the printing thereof.

26. The method according to claim 20, wherein the sub-process for positioning internal elements comprises fastening the auxiliary positioning elements to the internal elements and the main mould.

27. The method according to claim 20, wherein the step for reversible stiffening of the sub-process for positioning internal elements comprises freezing the soft internal elements.

28. The method according to claim 20, wherein the pouring step comprises the introduction, into the main or secondary mould, of the previously refrigerated pouring material.

29. The method according to claim 28, wherein the pouring material is refrigerated to 5° C. in a cooling step prior to pouring.

30. The method according to claim 28, wherein the pouring step also comprises a step for subjecting the pouring material to a vacuum prior to pouring.

31. The method according to claim 28, wherein in the pouring step, the pouring is performed at atmospheric pressure and also comprises, after pouring, a curing step in a reboiler at a pressure of 70 psi and at a controlled temperature of more than 25° C.

32. The method according to claim 22, wherein the demoulding step, when the main or secondary mould is made in PLA, comprises heating the assembly to a temperature between 60° C. and 100° C.

33. The method according to claim 32, wherein the heating is performed by subjecting the assembly to the action of a heated fluid.

34. The method according to claim 32, wherein the fluid is water.

35. The method according to claim 20, wherein the demoulding step of the sub-process for integrating the internal elements also comprises extracting any through auxiliary positioning elements and filling the holes of the spaces they occupied.

36. The method according to claim 35, wherein the filling of the holes produced by the auxiliary positioning elements is performed with the pouring material.

37. The method according to claim 20, wherein the post-processing sub-process comprises buffing to remove imperfections and to smooth out surfaces and the application of a protective lacquer.

38. The method according to claim 20, wherein the pouring material comprises urethane rubber.
